(19) United States
(12) Patent Application Publication
(10) Pub. No.: US 2026/0187398 A1
(43) Pub. Date: Jul. 2, 2026

(54) STORAGE MEDIUM STORING PROGRAM, SERVER, AND LABEL DATA SHARING SYSTEM

(71) Applicant: BROTHER KOGYO KABUSHIKI KAISHA, Nagoya (JP)

(72) Inventor: Jun YAMADA, Nagoya (JP)

(21) Appl. No.: 19/548,509

(22) Filed: Feb. 24, 2026

Related U.S. Application Data
(63) Continuation of application No. PCT/JP2024/028034, filed on Aug. 6, 2024.

(30) Foreign Application Priority Data
Sep. 29, 2023 (JP) 2023-169341

(51) Int. Cl. G06K 15/02; B41J 3/407

(52) U.S. Cl. CPC G06K 15/1809; B41J 3/4075

(57) ABSTRACT

A set of program instructions, when executed by a controller, causes a server to perform: in response to receiving, from a first information processing apparatus, a download request specifying one of a plurality of label data stored in a label database, transmitting specified label data and a label ID to the first information processing apparatus; acquiring print logs including a print log output from the first information processing apparatus when a label printer performs printing based on the label data received from the server, the print log including time information and the label ID; counting, based on the acquired print logs, a number of prints within a particular period for each label data; and in response to receiving a suggestion request from a second information processing apparatus, suggesting label data having a high print frequency based on the counted number of prints for each label data.

### REFERENCE TO RELATED APPLICATIONS

This is a Continuation Application of International Application No. PCT/JP 2024/028034 filed on Aug. 6, 2024, which claims priority from Japanese Patent Application No. 2023-169341 filed on Sep. 29, 2023. The entire content of each of the prior applications is incorporated herein by reference.

### BACKGROUND ART

A server for storing various content data is known.

### SUMMARY

A system for utilizing content data includes a server on the Internet that stores content data, where users upload content from their devices to the server, and other users download the content data from the server to their devices.

In a point management system, photo data uploaded from User A's PC to a WWW server is purchased and downloaded by User B's PC. Upon download, User B, the purchaser, is awarded points corresponding to the purchase amount. Further, User A, the uploader, receives points based on data size of photo data either at the time of upload or download.

Recently, systems have been proposed in which users upload label data used for label printing on label printers to a server, allowing other users to download the label data from the server for use. In such systems, as the number of label data stored on the server increases, selecting label data becomes cumbersome for users. This disclosure is to facilitate selection of content such as label data.

According to one aspect, this specification discloses a non-transitory computer-readable storage medium storing a set of program instructions for a server including a controller. The server is configured to access a label database. The label database is configured to store a plurality of label data and label IDs identifying respective ones of the plurality of label data. The set of program instructions, when executed by the controller, causing the server to perform, in response to receiving, from a first information processing apparatus, a download request specifying one of the plurality of label data stored in the label database, transmitting specified label data and a label ID identifying the specified label data to the first information processing apparatus. Thus, the specified label data and the label ID identifying the specified label data are transmitted to the first information processing apparatus. The set of program instructions, when executed by the controller, causing the server to perform acquiring print logs. The print logs include a print log that is output from the first information processing apparatus in a case where the first information processing apparatus causes a label printer to perform printing based on the label data received from the server. The print log includes time information and the label ID identifying the printed label data. Thus, the print log is acquired from the first information processing apparatus. The set of program instructions, when executed by the controller, causing the server to perform counting, based on the acquired print logs, a number of prints within a particular period for each of the plurality of label data stored in the label database. Thus, the number of prints within the particular period is counted for each of the plurality of label data. The set of program instructions, when executed by the controller, causing the server to perform, in response to receiving a suggestion request from a second information processing apparatus, suggesting label data having a high print frequency based on the counted number of prints for each of the plurality of label data. Thus, the label data having a high print frequency is suggested based on the counted number of prints for each of the plurality of label data.

The server storing the above-described program counts the number of prints for each label data within the particular period based on print logs received from the first information processing apparatus that instructed the label printer to print the label data. When the suggestion request is received from the second information processing apparatus, the server suggests label data having a high print frequency based on the counted number of prints for each label data. Thus, the server allows the second information processing apparatus to suggest label data having a high print frequency within the particular period to the user. This allows the user having made the suggestion request to recognize label data that other users frequently print, indicating higher utility, and to more easily select such label data.

A system, apparatus, control method, and a computer-readable storage medium storing the program to realize the functions of the above program are also novel and useful.

The technology disclosed herein enables a system that utilizes label data, allowing users to easily select label data to be downloaded.

### BRIEF DESCRIPTION OF DRAWINGS

FIG. 1 is a schematic diagram of a label data sharing system.

FIG. 2A illustrates an example of a user database.

FIG. 2B illustrates an example of a label database.

FIG. 2C illustrates an example of a tape database.

FIG. 3 illustrates an example of a print log database.

FIG. 4A is a sequence diagram illustrating an example of a posting (upload) process.

FIG. 4B is a sequence diagram illustrating an example of a download process.

FIGS. 5A, 5B, 5C and 5D illustrate examples of screen transitions.

FIG. 6 is a sequence diagram illustrating an example of a printing process.

FIG. 7 is a sequence diagram illustrating an example of a cache process.

FIG. 8 is a sequence diagram illustrating an example of a recommendation display process.

FIG. 9 is a flowchart illustrating an example of a count process.

FIG. 10A is a flowchart illustrating an example of a suggestion information generation process.

FIG. 10B is a flowchart illustrating an example of a suggestion information generation process.

### DESCRIPTION

An embodiment of a label data sharing system is described in detail with reference to the accompanying drawings. This embodiment discloses a label data sharing system in which a server and a plurality of information processing apparatuses are connected via a network to share label data used for printing labels on a label printer.

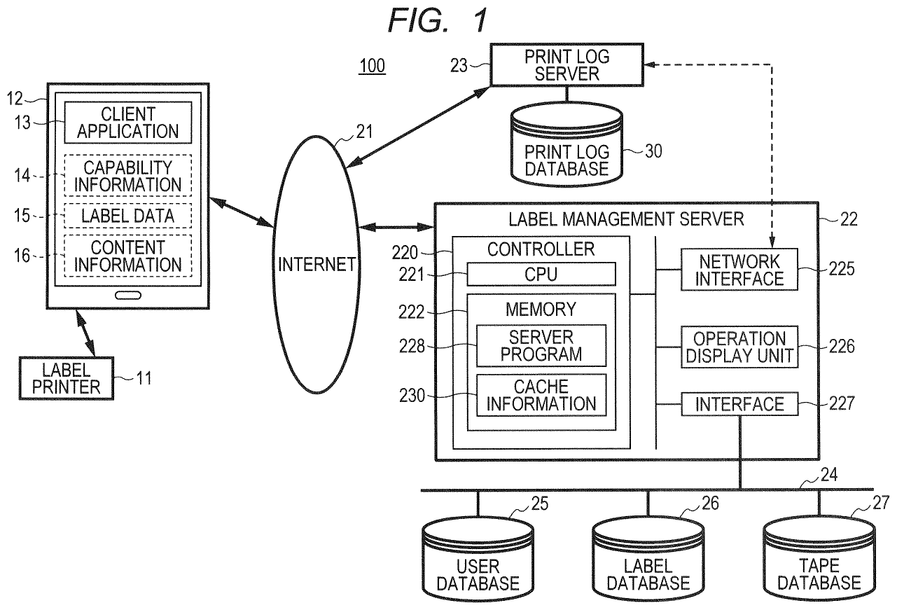

As shown in FIG. 1, a label data sharing system 100 (hereinafter referred to as “system 100”) is, for example, provided to users by a vendor of a label printer. The system 100 includes a terminal 12 and a label management server 22, which are connected via Internet 21. The terminal 12 is a device owned by a user of the label printer. The terminal 12 is connected to a print log server 23 via the Internet 21 and is also connected to a label printer 11. The label management server 22 connects to the print log server 23 and serves as an example of a server. The Internet 21 is an example of a network. Although FIG. 1 shows one terminal 12, in practice, many terminals 12 are connected to the label management server 22. The print log server 23 accesses a print log database (hereinafter “print log DB”) 30, and manages print logs generated when multiple terminals 12 print label data using the label printers 11.

The label printer 11 is a printing device including a thermal transfer print head, which prints while feeding tape from a roll. Based on a print job received from the terminal 12, the printer prints an image on the tape, conveys the tape, and ejects the printed portion. The ejected tape forms a label with a particular length and width. The label length refers to the dimension along the ejection direction, and the label width refers to the dimension perpendicular to the label length.

The label printer 11 connects to the terminal 12 via wireless LAN communication such as Wi-Fi or short-range wireless communication such as Bluetooth. Alternatively, the label printer 11 may be connected via a wired connection using USB communication standards. The “Wi-Fi” is a registered trademark of Wi-Fi Alliance. The “Bluetooth” is a registered trademark of Bluetooth SIG, Inc.

Various types of tape are usable with the label printer 11. Tape types may be distinguished by the width of the tape, the color of the tape or ink, the material of the tape, or presence of special processing on the tape. Each tape type is compatible with specific printer models. Users change the tape in the printer depending on their intended use or application.

The terminal 12 is an information processing apparatus having communication, display, and operation functions. In this embodiment, the terminal 12 is a smartphone, but the terminal 12 may also be a tablet or a personal computer. A client application program (hereinafter “client application”) 13 is stored in the terminal 12.

The terminal 12 acquires capability information 14 from the label printer 11 and stores the capability information 14. The capability information 14 includes, for example, an IP address, printer information, and tape information, which will be described later.

The client application 13 is an application program provided by the vendor of label printer 11. The client application 13 has functions to create and edit label data on the terminal 12. The client application 13 stores content information 16 of content downloaded from the label management server 22. The downloaded content is usable in creating and editing label data. The client application 13 has a function of posting, that is, uploading created label data to the label management server 22. The client application 13 has a function of downloading label data from the label management server 22. The client application 13 stores created or edited label data as well as label data downloaded from the label management server 22 in the terminal 12 as label data 15.

The client application 13 has a function of printing the label data 15 using the label printer 11. The client application 13 has a function of, when causing the label printer 11 to print label data, outputting a print log to the print log server 23 via the Internet 21. The client application 13 also has a function of requesting the label management server 22 to suggest label data having high print frequently. Thus, the terminal 12 may serve as an example of a third information processing apparatus that posts label data, a first information processing apparatus that prints label data and outputs a print log, or a second information processing apparatus that transmits a suggestion request. Each function of the client application 13 will be described later.

The label management server 22 is an apparatus having at least a storage function and a communication function. The label management server 22 includes a controller 220 including a CPU 221 and a memory 222. The label management server 22 further includes a network interface 225, an operation display unit 226, and an interface 227, all of which are connected to the controller 220. The CPU 221 is an example of a computer (controller). The controller 220 may also be an example of a computer (controller).

The CPU 221 executes various processes according to programs read from the memory 222 and based on user operations. The memory 222 stores various programs such as a server program 228 and various data such as cache information 230. The memory 222 also serves as a work area during the execution of these processes.

The server program 228 is a program for managing label data and printing of label data. The server program 228 accepts posting of label data and transmits the posted label data to the terminal. In response to receiving a suggestion request output from the terminal 12, the server program 228 counts the number of prints for each label data based on the print log and suggests label data having a high print frequency to the terminal 12. The server program 228 is an example of a program. The functions of the server program 228 are described below.

The cache information 230 is data acquired by the label management server 22 periodically counting the number of prints for each label data, independent of any suggestion request, and storing the number of prints for each label data in the memory 222. Further details of the cache information 230 are described below.

An example of the memory 222 shown in FIG. 1 is not limited to a ROM, a RAM, or an HDD built into the apparatus but may include any storage medium readable and writable by the CPU 221. The storage medium readable by the CPU 221 also includes recording mediums such as a CD-ROM and a DVD-ROM in addition to the above examples.

The operation display unit 226 includes hardware for displaying screens to notify the user of information and hardware for receiving user input. The operation display unit 226 may be a touch panel having both display and input functions, or may be a combination of a display and operation input devices such as a keyboard, mouse, or trackball.

The network interface 225 includes hardware for communication with external apparatuses such as the terminal 12 and the print log server 23. The communication standards of the network interface 225 include Ethernet and Wi-Fi. Communication by the network interface 225 may be wired or wireless. In this embodiment, the network interface 225 is connected to the Internet 21. The network interface 225 is connected to the print log server 23 via wired or wireless communication. The print log server 23 is connected to a print log database 30 and registers (stores) print logs. Details of the print log database 30 are described later.

The interface 227 is connected to a user database 25, a label database 26, and a tape database 27. In this embodiment, the interface 227 is connected to the user database 25, the label database 26, and the tape database 27 via a wired LAN 24. The user database 25, the label database 26, and the tape database 27 may be stored in the label management server 22, or may be stored in a server separate from the label management server 22. Further, the user database 25, the label database 26, and the tape database 27 may be stored in separate servers. The label management server 22 and the print log server 23 may be integrated, and for example, the label management server 22 may include the print log database 30.

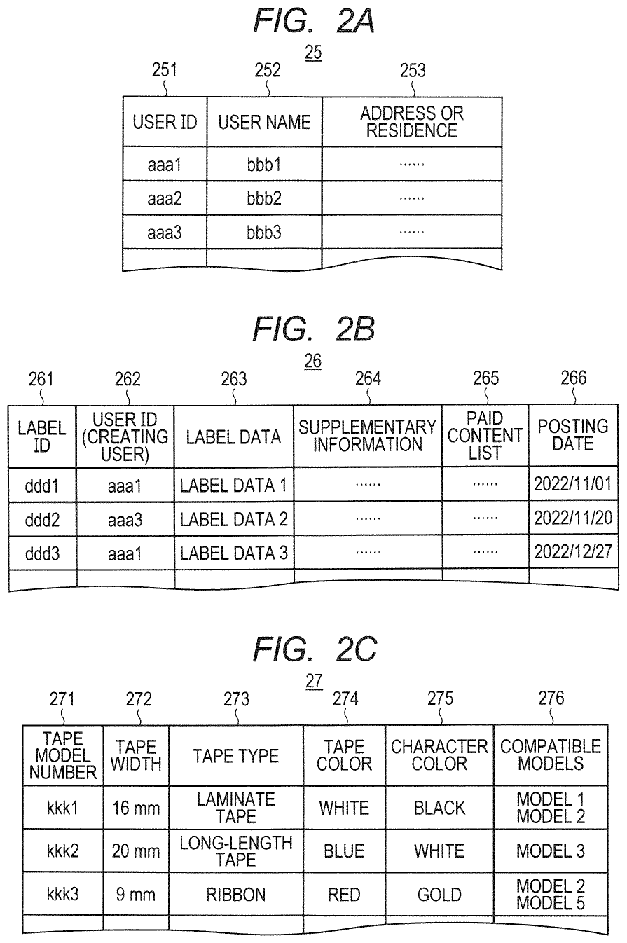

As shown in FIG. 2A, the user database 25 stores information about users authorized to access services provided by the system 100. The user database 25 contains records of a user ID 251, a user name 252, and an address or residence 253 associated with one another.

The user ID 251 is identification information used to identify a user authorized to access the system 100 and to specify the user operating the terminal 12. The user name 252 represents the personal or organizational name, nickname, or similar identifier of the user. The address or residence 253 specifies the location where the user operating the terminal 12 resides. The user ID 251 is newly assigned when the user first accesses the services provided by the system 100. For example, when the user uses the service provided by the system 100 for the first time, the user inputs a user name and address or residence via the terminal 12, which are then stored in association with the newly assigned user ID 251. The user database 25 may also store other personal information for each user, such as email addresses and phone numbers.

As shown in FIG. 2B, the label database 26 stores label data associated with a user ID. The label data stored in the label database 26 may be label data posted from the terminal 12 (hereinafter referred to as “posted label data”) or label data created by entities other than users, such as the vendor of the label printer. The label database 26 contains records of a label ID 261, a user ID (creating user) 262, label data 263, supplementary information 264, a paid content list 265, and a posting date 266 associated with one another.

The label ID 261 is a serial number sequentially assigned to each label data registered (stored) in the label database 26 in the system 100 of this embodiment. The user ID (creating user) 262 is the user ID 251 of the user who posted label data using the system 100. For label data created by entities other than users, the user ID (creating user) 262 may store an administrator ID, a vendor ID that created label data, or be left blank.

The label data 263 is stored in the label management server 22. The label data 263 includes information and arrangement of objects included in the label data, and, in a case where specific content or functions are used, the type and arrangement of such content are also stored. The label data may include tape information. The paid content list stores paid content IDs that identify paid content and functions set in the label data 263. The supplementary information 264 stores additional data that is added when registering (storing) label data in the label management server 22. The paid content list 265 stores paid content IDs identifying paid content or functions set in the label data 263. The posting date 266 indicates the date when the label data is posted.

As shown in FIG. 2C, the tape database 27 stores specifications for each tape model number. In this embodiment, the tape database 27 stores a tape model number 271 in association with a tape width 272, a tape type 273, a tape color 274, a character color 275, and compatible model(s) 276. The tape model number 271 identifies the tape type. The tape width 272 is the dimension perpendicular to the tape length fed from the label printer. The tape type 273 indicates the tape material, such as long-length tape, laminate tape, ribbon, masking tape, or half-cut label. The tape color 274 indicates the tape base color. The character color 275 indicates the color of the printed characters on the tape. The compatible model(s) 276 stores one or more compatible label printer model names.

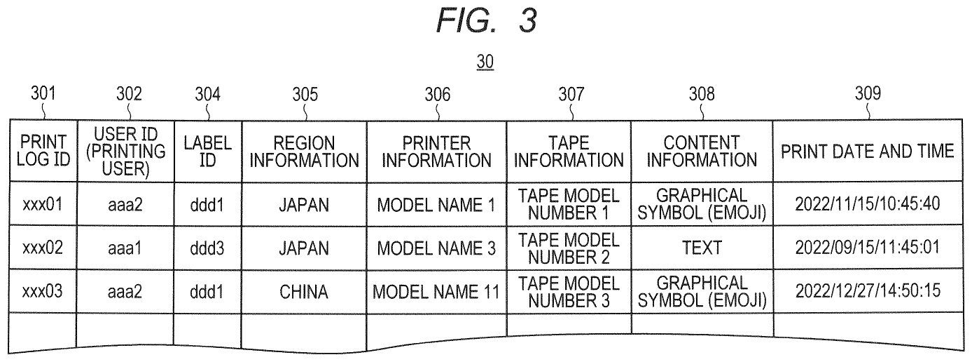

As shown in FIG. 3, the print log database 30 stores print logs output by the terminal 12. The print log database 30 contains, as a print log, records of a print log ID 301, a user ID (printing user) 302, a label ID 304, region information 305, printer information 306, tape information 307, content information 308, and a print date and time 309 associated with one another.

The print log ID 301 is a serial number sequentially assigned to each print log registered (stored) in the print log database 30. The user ID (printing user) 302 is the user ID 251 of the user who prints the label using the label printer 11. The label ID 304 stores the label ID assigned to the label data printed by the label printer 11.

The region information 305 indicates the region where the label data is printed. The printer information 306 identifies the printer that performed the printing. The tape information 307 indicates the tape used for printing. The content information 308 indicates the type of content included in the printed label data. The print date and time 309 indicates the year, month, day, and time when the label was printed by the label printer 11.

Next, the operation of the system 100 will be described. Each processing step in this embodiment mainly represents the processing performed by the CPU 221 according to instructions written in programs such as the server program 228. The processing by the CPU 221 includes hardware control using API of the OS. The operation of each program is described while omitting detailed descriptions of the OS. For convenience, the entity performing each process may be referred to as the terminal 12 or the label management server 22.

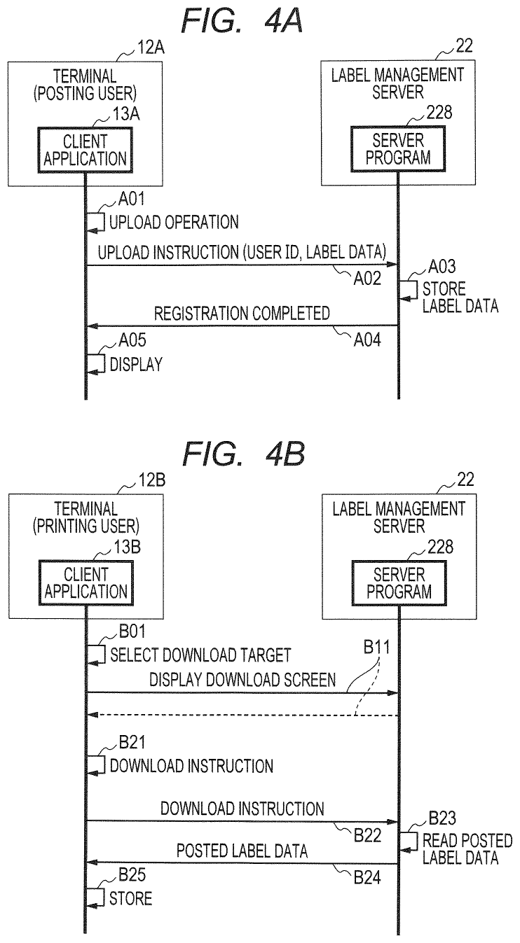

Referring to FIG. 4A, a posting process of posting label data to the label management server 22 will be described. In this example, a user A (hereinafter “posting user A”) posts (uploads) label data 15A created on a terminal 12A. For convenience, a suffix “A” is attached to reference numerals for the user, terminal, its components, and label data.

As shown in the sequence diagram of FIG. 4A, the posting user A launches a client application 13A on the terminal 12A and performs an upload operation on the terminal 12A (A01). For example, the client application 13A, while logged into the label management server 22, displays a posting screen (not shown) provided by the label management server 22 on the terminal 12A. The posting user A selects label data 15A to be posted (uploaded) via the posting screen (not shown). The posting user A inputs supplementary information into the posting screen (not shown), such as a label name, category, description of the label data, and use example images. When the posting user A taps a new post button on the posting screen (not shown), the label management server 22 accepts an upload instruction (A02). The label management server 22 receives the user ID of the logged-in posting user A, the label data 15A that is posted (hereinafter “posted label data”), and the supplementary information entered on the posting screen (not shown), along with the upload instruction. Step A02 is an example of an upload acceptance process.

The label data 15A stores content information indicating the type of content included in the label data 15A, tape information received when creating label data, printer information of a label printer 11A, and region information of the region where the label printer 11A is used. The content information may be a content ID, for example. The content information may be a content ID of either paid content or free content. The tape information may be a tape model number, for example. The printer information may be the model name of the label printer 11A, for example. The region information may be country information, for example.

The label management server 22 accesses the label database 26 via the interface 227 and stores the received posted label data 15A (A03). Step A03 is an example of a registration process. Specifically, the label management server 22 generates a new label ID as a new label ID 261, and creates a record including the new label ID 261 in the label database 26. The label management server 22 then stores the user ID 251 of the posting user A as the user ID (creating user) 262, stores the received posted label data 15A as the label data 263, stores the received supplementary information as the supplementary information 264, and stores the posting date as the posting date 266 in the record including the new label ID 261. Further, the label management server 22 creates a paid content list containing paid content IDs stored within the posted label data 15A and stores this list as the paid content list 265.

In response to completing storage of the posted label data 15A, the label management server 22 notifies the terminal 12A of “Registration Completed” (A04). In response to receiving the notification “Registration Completed”, the terminal 12A displays a message indicating that registration of the posted label is completed (A05). This allows the posting user A to recognize that the posting is completed.

Referring to FIG. 4B, a download process for downloading posted label data is described. For example, the user B (hereinafter “printing user B”) downloads posted label data 15A, posted by the posting user A, to a terminal 12B. For convenience, a suffix “B” is attached to reference numerals for the user, the terminal, and its components. The terminal 12B is an example of a first information processing apparatus. The downloadable data may also include label data registered by entities other than users, such as the vendor of the label printer.

For example, when a client application 13B is launched on the terminal 12B, the terminal 12B displays a home screen (not shown) provided by the client application 13B. The home screen (not shown) includes a server use button (server access button) for using the label management server 22.

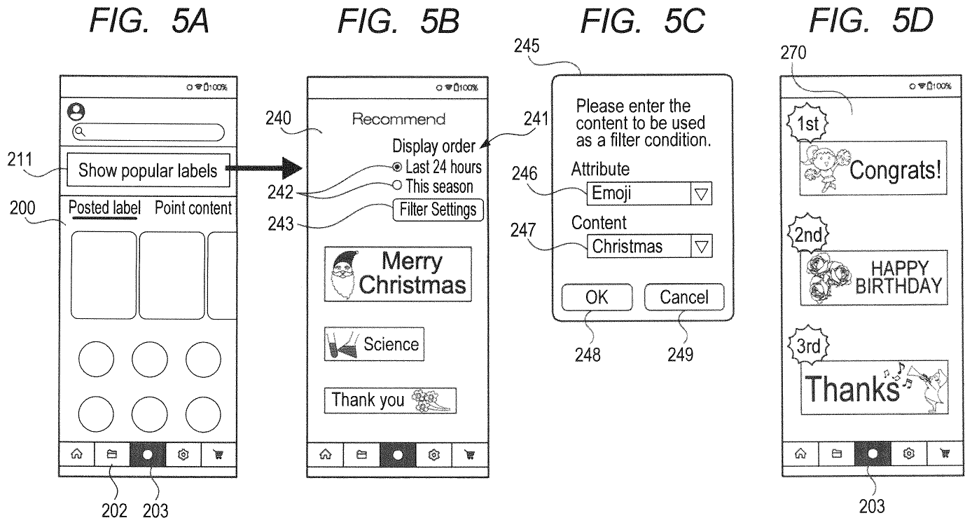

In response to receiving a server use instruction via the server use button (not shown), the client application 13B displays a label search screen 200, provided by the label management server 22, on the terminal 12B as shown in FIG. 5A. The label search screen presents downloadable label data as images or thumbnails, each linked to a corresponding label ID. For example, as illustrated in FIG. 4B, the client application 13B accepts a selection of a download target (label data to be downloaded) when the image corresponding to the posted label data 15A is tapped on the label search screen 200 (B01). In response to selection of the download target, the label management server 22 provides a download screen (not shown) to the client application 13B for display on the terminal 12B (B11).

The download screen (not shown) includes a download execution button. The client application 13B accepts a download instruction in response to an operation of the download execution button (B21) and transmits the download instruction to the label management server 22 (B22). The label management server 22 accesses the label database 26 and, based on the label ID associated with the image selected in B01, reads the posted label data 15A from the label database 26 (B23). The label management server 22 transmits the read posted label data 15A to the terminal 12B (B24).

The client application 13B of the terminal 12B stores the received posted label data 15A (B25). Processing in B01, B11, and B21 to B25 is an example of a download process. Processing in B24 is an example of a transmission process. The printing user B may select a plurality of label data on the label search screen and download the plurality of label data to the terminal 12B.

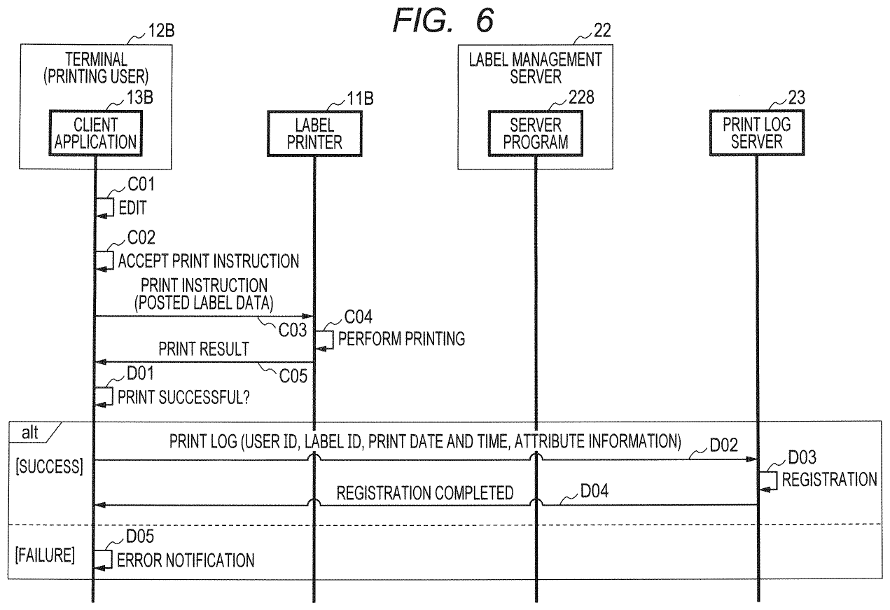

Referring to FIG. 6, a printing process for printing label data is described. As an example, the printing user B edits and prints the downloaded posted label data 15A. For convenience, the suffix “B” is attached to reference numerals for the user, the terminal, and its components.

For example, when the printing user B taps a file button 202 shown in FIG. 5A, the client application 13B displays a list of label data stored on the terminal 12B. When the printing user B taps the posted label data 15A in the list, the client application 13B opens the posted label data 15A and displays its content on an editing screen. The client application 13B accepts editing operations for the posted label data 15A on the editing screen (C01).

In response to receiving a print command via the editing screen (C02), the client application 13B transmits a print instruction to a label printer 11B selected during print settings (C03). The print instruction includes the edited posted label data 15A. The label printer 11B executes printing of the posted label data 15A (C04) and transmits the print result back to the client application 13B (C05).

The client application 13B receives the print result from the label printer 11B and determines whether the print is successful (D01). In response to determining that the print is successful (alt: success), the client application 13B outputs a print log to the print log server 23 (D02). Step D02 is an example of an output process. The client application 13B may output a print log generated by the client application 13B itself, or may acquire a print log from the label printer 11B and output the acquired print log. The print log includes the user ID of the printing user B, the label ID of the printed posted label data 15A, and the print date and time when the label data 15A was printed. The print date and time may be the time when printing is completed or the time when the print job is input to the printer. The print date and time may include the day of the week. The print date and time is an example of time information. The print log may also include attribute information indicating attributes of the printed label data.

The attribute information includes, for example, region information, printer information, tape information, and content information. The region information, the printer information, and the tape information are information based on capability information 14B of the label printer 11B stored in the terminal 12B. The capability information 14B is acquired when the terminal 12B connects to the label printer 11B, when the terminal 12B accepts print settings, when the terminal 12B transmits the posted label data 15A to the label printer 11B, or when the terminal 12B receives a print result.

For example, the capability information 14B includes the IP address of the label printer 11B. The IP address contains region information indicating the region (location). The client application 13B acquires the region information from the IP address and stores the region information in the print log. The client application 13B also stores, in the print log, the model name of the label printer 11B as the printer information. The client application 13B stores, in the print log, the tape model number acquired from the tape installed in the label printer 11B, as the tape information. The tape information may also be the tape model number stored in the terminal 12B by reading a QR code attached to the tape or its packaging at the time of purchase. The tape information may include a tape width, a tape type, a tape color, or a character color.

The client application 13B stores, in the print log, the type of content contained in the printed label data as the content information. The contents may include font of texts, emoji, shape, symbol mark, image, frame, and two-dimensional code, for example.

The print log server 23 registers (stores) the print log output from the terminal 12B into the print log database 30 (D03). Specifically, the print log server 23 generates a new print log ID and stores the new print log ID in the print log ID 301 of the new record. The print log server 23 also stores the user ID, the label ID, the region information, the printer information, the tape information, the content information, and the print date and time included in the received print log into the user ID 302, the label ID 304, the region information 305, the printer information 306, the tape information 307, the content information 308, and the print date and time 309 of the new record, respectively.

In response to completing registration of the print log, the print log server 23 notifies the terminal 12B of the registration completion (D04). When the client application 13B receives a printing result indicating failure (alt: failure) from the label printer 11B, the client application 13B issues an error notification (D05).

The print log database 30 stores print logs output from all the terminals 12 and the label printers 11 that constitute the system 100, not limited to the terminal 12B.

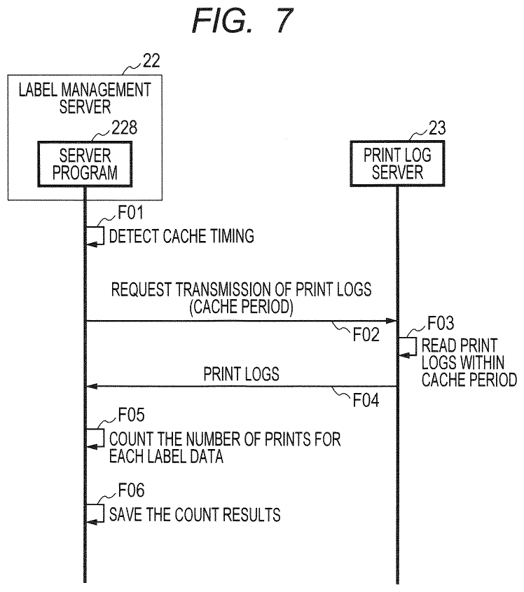

Referring to FIG. 7, a cache process is described. The label management server 22 executes the cache process by executing the server program 228.

In response to detecting a cache timing to execute the cache process (F01), the label management server 22 requests the print log server 23 to transmit print logs (F02). The cache process is a process of periodically counting the number of prints for each label data within a cache period, regardless of suggestion requests output from the client application 13. That is, the cache timing is independent of suggestion requests. The request in F02 includes the cache period.

The cache timing may be a particular date, such as the beginning or end of a month, or when a particular period (such as three months) has elapsed after the last caching. The cache timing may also be set based on the day of the week. Furthermore, the cache timing is not limited to date or time conditions; for example, the cache timing may be triggered when a particular number of print logs are detected within a particular time period.

The cache period specifies the period used for counting in the cache process. The cache timing and cache period are set by the administrator of the label management server 22. The cache period may be fixed, such as from January to March, or variable, such as one year from a specified date. The cache period may be sufficiently long to encompass an increased number of print logs subject to counting. Examples of the cache period include seasons (spring, summer, autumn, and winter), specific events like Christmas or school entrance ceremonies, or fixed durations such as quarterly or annual periods independent of seasons or events.

In response to receiving a request from the label management server 22 (F02), the print log server 23 accesses the print log database 30, acquires print logs with the print date and time 309 included within the cache period specified in the request (F03), and transmits the print logs to the label management server 22 (F04). The label management server 22 receives the print logs via the network interface 225 and counts the number of prints for each label data (F05).

In response to completing counting the number of prints for all the acquired print logs, the label management server 22 stores the count results as the cache information 230 in the memory 222 (F06). The cache information 230 is stored in association with the cache period. For example, the label management server 22 sets June 1, which is the transition date from spring to summer, as the cache timing. In a case where the cache period is “spring,” the label management server 22 acquires print logs of label data printed from March 1 to May 31, counts the number of prints for each label ID in the acquired print logs, and stores, as the cache information 230, the count results associated with the cache period “spring”.

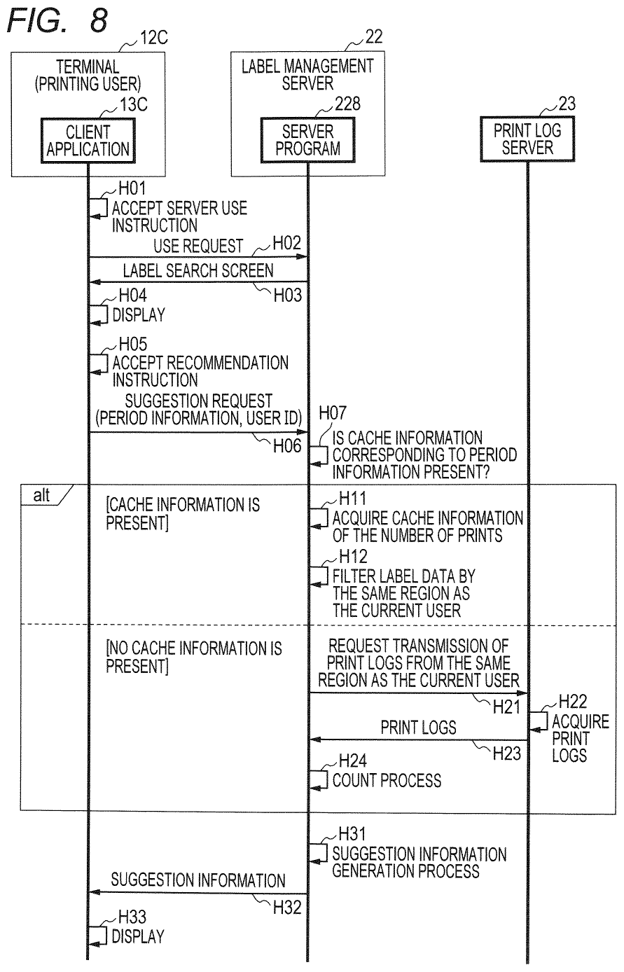

Referring to FIG. 8, a recommendation display process is described. The label management server 22 executes the recommendation display process by executing the server program 228. In this example, the label management server 22 receives a suggestion request from a terminal 12C and suggests label data having a high print frequency via the terminal 12C. For convenience, a suffix “C” is attached to reference numerals for the user, the terminal, and its components.

For example, when a client application 13C accepts a server use instruction by a user C (hereinafter, “suggestion requesting user C”) operating a server use button 203 (H01), the client application 13C transmits a use request to the label management server 22 (H02). In response to receiving the use request, the label management server 22 provides a label search screen to the client application 13C (H03), causing the terminal 12C to display the label search screen (H04). For instance, the label search screen 200 shown in FIG. 5A includes a popular label display button 211. The popular label display button 211 is an object (UI element) to accept an instruction to view label data having a high print frequency, that is, popular label data. In this embodiment, the popular label display button 211 appears on the screen provided by the label management server 22 but may alternatively appear on a screen provided by client application 13C.

When the suggestion requesting user C taps the popular label display button 211, the client application 13C accepts a recommendation instruction (H05) and transmits a suggestion request (recommendation request) to the label management server 22 as shown in FIG. 8 (H06). The suggestion request includes period information specifying the period for displaying popular label data. In the client application 13C of this embodiment, the default period specified by the period information is set to “within the last 24 hours.” The suggestion request also includes the user ID of the suggestion requesting user C.

As shown in FIG. 8, in response to receiving the suggestion request via the network interface 225 (H06), the label management server 22 determines whether cache information corresponding to the period information attached to the suggestion request is stored (H07). In this embodiment, “within the last 24 hours” is a short period, and no corresponding cache information is stored in the memory 222. When no cache information is stored for the specified period (alt: no cache information is stored), the label management server 22 requests the print log server 23 to transmit print logs from the same region as the current user (H21). This is because the suggestion requesting user C is likely to use label data suited to their residential region. Step H21 is an example of an acquisition process.

For example, the label management server 22 accesses the user database 25 to retrieve the address or residence 253 associated with the user ID of the suggestion requesting user C attached to the suggestion request. Based on the retrieved address or residence 253, the label management server 22 identifies the region where the suggestion requesting user C resides. The label management server 22 then requests the print log server 23 to transmit print logs by specifying the identified region.

The print log server 23 accesses the print log database 30 to acquire all print logs in which the specified region is stored as the region information 305 (H22), then transmits the print logs to the label management server 22 (H23). In response to receiving the print logs via the network interface 225, the label management server 22 performs a count process (H24). The count process is a process of counting the number of prints for each label data stored in the label database 26 that were printed within a particular period, based on the received print logs.

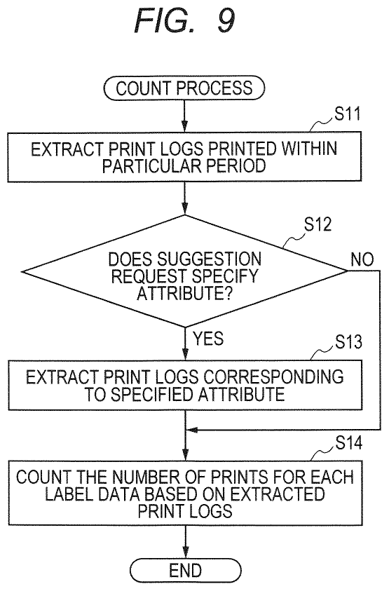

As shown in FIG. 9, the CPU 221 of the label management server 22 extracts print logs printed within the particular period (S11). The particular period is specified by the period information. Here, the particular period is “last 24 hours.” The label management server 22 extracts print logs with the print date and time 309 recorded between the current time and 24 hours before the current time, from the print logs acquired in H23.

The CPU 221 determines whether the suggestion request specifies an attribute (S12). At this point, the suggestion request does not include attribute information. In this case, the label management server 22 determines that no attribute is specified in the suggestion request (S12: NO), the label management server 22 counts the number of prints for each label data based on the print logs extracted in S11 (S14). For example, the label management server 22 extracts print logs containing the same label ID and counts the number of prints. The CPU 221 completes the count process after counting the number of prints for all print logs extracted in S11.

The label management server 22 may specify a period when acquiring print logs from the print log server 23 in H22, thereby acquiring the print logs corresponding to the specified region and the specified period. In this case, step S11 in FIG. 9 may be omitted.

Referring back to FIG. 8, in response to completing the count process in H24, the label management server 22 executes a suggestion information generation process of generating suggestion information (H31). The suggestion information is information for suggesting label data having a high print frequency.

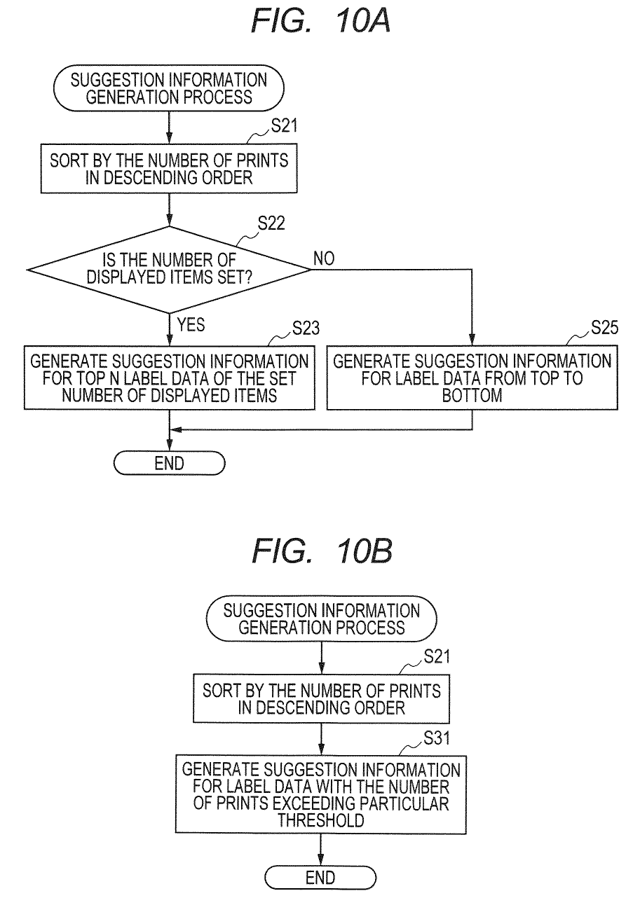

In the suggestion information generation process H31, as shown in FIG. 10A, the CPU 221 of the label management server 22 sorts the label data in descending order of print frequency (S21). The CPU 221 then determines whether the number of displayed items is set (S22). The number of displayed items may be set on the label management server 22 or based on an instruction from the client application 13C. By setting the number of displayed items to “1”, one label data with the highest print frequency may be suggested. By setting the number of displayed items to “2 or more”, a plurality of label data with high print frequencies may be suggested.

In a case where the number of displayed items is set (S22: YES), the label management server 22 generates suggestion information for the top labels up to the number of displayed items from the label data sorted in S21 (S23). Labels with low print frequency are excluded from suggestions, thereby facilitating user's selection.

In a case where no number of displayed items is set (S22: NO), the label management server 22 generates suggestion information using the label data from the top to the bottom (S25). This allows the suggestion requesting user C to review the label data printed within the specified period.

Referring back to FIG. 8, the label management server 22 transmits the suggestion information generated in H31 to the client application 13C of the terminal 12C (H32). Steps H31 and H32 illustrate an example of a suggestion process. Based on the received suggestion information, the client application 13C displays the label data having a high print frequency, that is, popular labels, on the terminal 12C (H33).

For example, a suggestion screen 240 shown in FIG. 5B displays label images to help the suggestion requesting user C easily understand the content of the label data. Label data with higher number of prints tends to have greater utility. Therefore, in the suggestion screen 240, label data with higher number of prints may be displayed in higher positions. In this case, the label data may be ranked and displayed accordingly. The number of downloads for each suggested label data may also be displayed.

The method for suggesting label data is not limited to the example shown in FIG. 5B. For instance, an image illustrating a label usage example may be displayed alongside the label image for each label data. Further, the label usage example, the label name, the creating user's name, and the number of downloads may be displayed for each label data. In this case, the label image may or may not be included.

The suggestion screen 240 includes a designation field 241 for specifying the display target (label data to be displayed). The designation field 241 contains radio buttons 242 to select the period of the display target. The client application 13C allows changing the period specified by the radio buttons 242 between “last 24 hours” and “this season.” Alternatively, the designation field 241 may allow the suggestion requesting user C to specify any period.

In the designation field 241, a filter condition setting button 243 is provided. The filter condition setting button 243 is an object (UI element) that accepts an instruction to set a filter condition other than the period. When the suggestion requesting user C taps the filter condition setting button 243 in a state where “last 24 hours” is selected, for example, the client application 13C displays a filter setting screen 245 shown in FIG. 5C on the terminal 12C. The filter setting screen 245 includes an attribute input field 246, a content input field 247, an OK button 248, and a cancel button 249. The attribute input field 246 accepts input specifying an attribute. The content input field 247 accepts input specifying content selectable based on the specified attribute.

For example, when the suggestion requesting user C enters tape information in the attribute input field 246, the content input field 247 automatically displays the tape model number included in capability information 14C acquired from a label printer 11C. The content input field 247 may also automatically display any of the label width, the tape type, the label color, or the character color corresponding to the tape model number. The content input field 247 may display tape model numbers compatible with the model of the label printer 11C. When the suggestion requesting user C presses the OK button 248, the client application 13C transmits a suggestion request with attribute information including the specified attribute “tape information” and content type “tape model number” to the label management server 22, as shown in H06 in FIG. 8.

The CPU 221 of the label management server 22 determines in the count process shown in FIG. 9 that the suggestion request specifies an attribute (S12: YES). In this case, in S13, the CPU 221 extracts print logs corresponding to the specified tape model from the print logs acquired based on the time period specified in S11 (within the last 24 hours). For example, the CPU 221 extracts print logs in which the specified tape model is recorded in the tape information 307. The processing from step S14 onward is as described above and is omitted here.

This allows the label management server 22 to cause the terminal 12C to display a suggestion screen 270, as shown in FIG. 5D, which suggests label data associated with the tape model number specified in the suggestion request and printed within the period specified in the suggestion request (within the last 24 hours). This allows the label management server 22 to suggest, via the terminal 12C, popular label data compatible with tapes owned by the suggestion requesting user C. This allows the suggestion requesting user C to avoid print failures by downloading label data that are not compatible with tapes he or she owns.

For example, when the suggestion requesting user C enters printer information in the attribute input field 246 of FIG. 5C, the content input field 247 automatically displays the model name included in the capability information 14C acquired from the label printer 11C. When the suggestion requesting user C presses the OK button 248, the client application 13C outputs a suggestion request to the label management server 22 in H06 in FIG. 8, attaching attribute information including the specified attribute “model information” and content type “model name.” In this case, the label management server 22 extracts, in S13 in FIG. 9, print logs in which the specified printer name is recorded in the printer information 306. This allows the label management server 22 to suggest label data that is printable by the label printer 11C used by the suggestion requesting user C, thereby avoiding print failures.

For example, when the suggestion requesting user C inputs “emoji” in the attribute input field 246 of FIG. 5C, in the content input field 247, emojis that have been purchased by the suggestion requesting user C are automatically displayed in a selectable manner. In a case where the user database 25 stores purchase information indicating the types of content and functions purchased by each user, the label management server 22 retrieves the purchase information associated with the user ID “aaa3” of the suggestion requesting user C from the user database 25. The label management server 22 extracts the content information of emojis from the retrieved purchase information and displays the emojis (not shown) as selectable options in the content input field 247. When the suggestion requesting user C selects, for example, a “Santa Claus” emoji (not shown) from the displayed options, in S13 in FIG. 9, the label management server 22 extracts print logs in which the specified Santa Claus emoji is recorded in the content information 308. This allows the label management server 22 to suggest label data including the Santa Claus emoji requested by the suggestion requesting user C, and allows the suggestion requesting user C to download the suggested label data for editing or printing. Alternatively, as shown in FIG. 5C, in the content input field 247, categories of emojis that have been purchased by the suggestion requesting user C may be automatically displayed as selectable options. In this case, the suggestion requesting user C pulls down the content input field 247 and selects one of the categories. FIG. 5C illustrates a state where a category “Christmas” is selected. When the suggestion requesting user C selects the category “Christmas” from the displayed options, in S13 in FIG. 9, the label management server 22 extracts print logs in which emoji belonging to the category “Christmas” is recorded in the content information 308.

Assume that the suggestion requesting user C has changed the period set in the designation field 241 of the suggestion screen 240 shown in FIG. 5B from “last 24 hours” to “this season.” The label management server 22 periodically counts the number of prints for this season and stores the count result as the cache information 230 in the memory 222. In a case where “this season” is “spring”, in H07 of FIG. 8, the label management server 22 reads the cache information 230 corresponding to “spring” from the memory 222 (alt: cache information is present, H11). The label management server 22 then identifies the region where the suggestion requesting user C resides based on the user ID of the suggestion requesting user C and extracts print logs in which the identified region is recorded in the region information 305 (H12). The method for identifying the region is described in H21 and is omitted here. Subsequently, the label management server 22 executes the suggestion information generation process (H31). The processing after H31 has been described above and is omitted here.

In a case where the period of the display target is long like a season, it may take significant time for the label management server 22 to count the number of prints for each label due to the large volume of print logs. In this embodiment, however, the label management server 22 periodically counts the number of prints in the season at timings independent of suggestion requests, caches (stores) the count results as the cache information 230, and utilizes this cache when a suggestion request is received. This enables faster extraction of label data to be suggested.

As described above, the label management server 22 storing the server program 228 of this embodiment counts, for each label data, the number of prints within a particular period specified by the period information, based on print logs received from the terminal 12B that instructed the label printer 11B to print the label data. In response to receiving a suggestion request from the terminal 12C, the label management server 22 suggests label data having a high print frequency based on the counted number of prints. This allows the label management server 22 to suggest label data that are frequently printed within the particular period to the suggestion requesting user C via the terminal 12C. This allows the suggestion requesting user C to identify label data that other users print frequently, indicating higher utility, and to easily select such label data. The server program 228 of this embodiment allows the user to easily select label data to be downloaded in the system 100 for utilizing label data.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

For example, in the above embodiment, print frequency is determined solely by the number of prints. However, when determining the print frequency, a higher weight (more importance) is given to recent prints than to older ones.

The suggestion request may be output from the client application 13C at a timing other than when the popular label display button 211 is operated. For example, the client application 13C may output the suggestion request when an image displayed on the label search screen 200 shown in FIG. 5A is tapped to instruct displaying particular label data. This allows the label management server 22 to suggest label data in conjunction with display of templates. For instance, the client application 13C may automatically transmit a suggestion request in response to accepting an operation of the server use button 203. In this case, the popular label display button 211 may be omitted on the label search screen 200. This allows the label management server 22 to automatically suggest label data on the label search screen 200. This also allows the user to easily check label data having a high print frequency with fewer operations and to easily select the download target.

The particular period in S11 of FIG. 9 may be fixed. For example, the designation field 241 of the suggestion screen 240 may not include an item for specifying the period.

In the suggestion information generation process, instead of steps S22, S23, and S25 shown in FIG. 10A, the suggestion information may be generated based on label data of which the number of prints exceeds a particular threshold (S31) as shown in FIG. 10B. Suggesting all label data with the number of prints above the threshold increases the flexibility of user selection, while excluding label data with a low number of prints increases the reliability of suggestion. The particular threshold may be fixed or variable. In case of variable, the threshold may be set by an administrator or may be adjusted based on the total number of prints. For example, the threshold may be 10 in a case where the total number of prints is below 100, and the threshold may be 100 in a case where the total number of prints is below 1000. Higher print frequency tends to indicates a greater value of label data. Thus, by suggesting a set number of label data in descending order of the number of prints, the user easily selects label data of a high use value. Limiting the number of suggested labels prevents an overwhelming quantity, reducing difficulty in selecting label data.

The suggestion request output by the client application 13C may not include the attribute information. However, in a case where the suggestion request includes the attribute information, the label management server 22 limits suggestions not only by the period but also by the attribute, enabling the label management server 22 to suggest label data better suited to the user's purpose. The attribute information may differ from the region information, the printer information, the tape information, and the content information. The suggestion request may include attribute information specifying a plurality of attributes.

In the designation field 241 of the suggestion screen 240 shown in FIG. 5B, the period for determining displayed label data may be specified by the user. This allows the label management server 22 to suggest label data better suited to the user's purpose. The specified period may be a past period prior to the current time, such as the past week or past year, or another period like weekends, weekdays, summer, or winter. This allows the label management server 22 to suggest label data more suited to the user's purpose.

The cache process in FIG. 7 may not be executed. Steps H03, H11, and H12 in FIG. 8 may be omitted. However, in a case where the counting period is long, acquiring the cache information 230 beforehand allows the label management server 22 to quickly extract label data to be suggested.

The label management server 22 may count label data that have been posted by users. This allows the label management server 22 to suggest posted label data having a high print frequency, thereby promoting the use of the posted label data.

The label management server 22 may include a front-end server having a web server function and a back-end server having a function other than a web server function. For example, the front-end server may accept download requests and suggestion requests via the web server function and transmit label data and suggestion information, while the back-end server may acquire print logs and count the number of prints.

The print log database 30 may store print logs output by the terminal 12 and, in a case where the label printer 11 has a print log output function, may also store print logs output by the label printer 11.

In any sequence diagram disclosed in the embodiments, a plurality of processes may be executed in any order or in parallel, provided that no contradictions occur.

The processes disclosed in the embodiments may be executed by a single CPU, a plurality of CPUs, hardware such as an ASIC, or any combination of CPU(s) and ASIC(s). Further, these processes may be implemented in various forms, including recording medium storing a program for executing the processes, or a method for executing the processes.

What is claimed is

1. A non-transitory computer-readable storage medium storing a set of program instructions for a server comprising a controller, the server being configured to access a label database, the label database being configured to store a plurality of label data and label IDs identifying respective ones of the plurality of label data, the set of program instructions, when executed by the controller, causing the server to perform:
in response to receiving, from a first information processing apparatus, a download request specifying one of the plurality of label data stored in the label database, transmitting specified label data and a label ID identifying the specified label data to the first information processing apparatus;
acquiring print logs, the print logs including a print log that is output from the first information processing apparatus in a case where the first information processing apparatus causes a label printer to perform printing based on the label data received from the server, the print log including time information and the label ID identifying the printed label data;
counting, based on the acquired print logs, a number of prints within a particular period for each of the plurality of label data stored in the label database; and
in response to receiving a suggestion request from a second information processing apparatus, suggesting label data having a high print frequency based on the counted number of prints for each of the plurality of label data.

2. The non-transitory computer-readable storage medium according to claim 1, wherein the suggesting includes extracting a fixed number of label data in descending order of the counted number of prints for each of the plurality of label data, and suggesting the extracted fixed number of label data.

3. The non-transitory computer-readable storage medium according to claim 1, wherein the suggesting includes extracting label data having the number of prints exceeding a particular threshold based on the counted number of prints for each of the plurality of label data, and suggesting the extracted label data.

4. The non-transitory computer-readable storage medium according to claim 1, wherein the print log includes attribute information indicating an attribute;
wherein the set of program instructions, when executed by the controller, causes the server to perform:
in response to receiving, from the second information processing apparatus, the suggestion request specifying an attribute,
counting, based on the acquired print logs, the number of prints having the specified attribute and printed within the particular period for each of the plurality of label data stored in the label database; and
suggesting the label data having a high print frequency based on the number of prints for each of the plurality of label data counted in accordance with the specified attribute.

5. The non-transitory computer-readable storage medium according to claim 4, wherein the attribute information is region information indicating a region of printing; and
wherein the counting includes, in response to receiving, from the second information processing apparatus, the suggestion request specifying the region as the attribute, counting, based on the acquired print logs, the number of prints within the particular period in the specified region for each of the plurality of label data stored in the label database.

6. The non-transitory computer-readable storage medium according to claim 4, wherein the attribute information is printer information indicating a printer type of the label printer that performs printing; and
wherein the counting includes, in response to receiving, from the second information processing apparatus, the suggestion request specifying the printer type as the attribute, counting, based on the acquired print logs, the number of prints within the particular period by the specified printer type for each of the plurality of label data stored in the label database.

7. The non-transitory computer-readable storage medium according to claim 4, wherein the attribute information is tape information indicating a tape type of a tape used for printing; and
wherein the counting includes, in response to receiving, from the second information processing apparatus, the suggestion request specifying the tape type as the attribute, counting, based on the acquired print logs, the number of prints within the particular period by the specified tape type for each of the plurality of label data stored in the label database.

8. The non-transitory computer-readable storage medium according to claim 4, wherein the attribute information is content information indicating a content type of content included in the printed label data; and
wherein the counting includes, in response to receiving, from the second information processing apparatus, the suggestion request specifying the content type as the attribute, counting, based on the acquired print logs, the number of prints within the particular period for each label data including the specified content type among the plurality of label data stored in the label database.

9. The non-transitory computer-readable storage medium according to claim 1, wherein the set of program instructions, when executed by the controller, causes the server to perform:
in response to receiving the suggestion request specifying a period from the second information processing apparatus,
counting, based on the acquired print logs, the number of prints within the specified period as the particular period for each of the plurality of label data stored in the label database; and
suggesting the label data having a high print frequency based on the counted number of prints for each of the plurality of label data in accordance with the specified period.

10. The non-transitory computer-readable storage medium according to claim 1, wherein the set of program instructions, when executed by the controller, causes the server to perform:
storing, in a memory of the server, the counted number of prints for each of the plurality of label data;
in response to receiving the suggestion request from the second information processing apparatus,
in a case where the number of prints for each of the plurality of label data is stored in the memory, reading the number of prints for each of the plurality of label data from the memory, and suggesting the label data having a high print frequency based on the read number of prints for each of the plurality of label data; and
in a case where the number of prints for each of the plurality of label data is not stored in the memory, counting, based on the acquired print logs, the number of prints within the particular period for each of the plurality of label data stored in the label database; and
suggesting the label data having a high print frequency based on the number of prints for each of the plurality of label data counted in response to the suggestion request.

11. The non-transitory computer-readable storage medium according to claim 1, wherein the set of program instructions, when executed by the controller, causes the server to perform:
receiving an upload instruction of label data from a third information processing apparatus;
in response to receiving the upload instruction, receiving posted label data that is label data uploaded from the third information processing apparatus, and storing, in the label database, the received posted label data with the label ID identifying the posted label data; and
in response to receiving the download request specifying the posted label data from the first information processing apparatus, transmitting the posted label data to the first information processing apparatus.

12. The non-transitory computer-readable storage medium according to claim 1, wherein the set of program instructions, when executed by the controller, causes the server to perform:
detecting a cache timing, the cache timing being independent of the suggestion request;
in response to detecting the cache timing, transmitting a print log transmission request of requesting print logs to a print log server, the print log transmission request including a cache period for counting the number of prints for each of the plurality of label data;
receiving the print logs from the print log server;
counting the number of prints for each of the plurality of label data; and
storing, in a memory of the server, the counted number of prints for each of the plurality of label data in association with the cache period.

13. A server configured to be connected to a first information processing apparatus and a second information processing apparatus via a network, the server being configured to access a label database, the label database being configured to store a plurality of label data and label IDs identifying respective ones of the plurality of label data,
the server being configured to perform:
in response to receiving, from the first information processing apparatus, a download request specifying one of the plurality of label data stored in the label database, transmitting specified label data and a label ID identifying the specified label data to the first information processing apparatus;
acquiring print logs, the print logs including a print log that is output from the first information processing apparatus in a case where the first information processing apparatus causes a label printer to perform printing based on the label data received from the server, the print log including time information and the label ID identifying the printed label data;
counting, based on the acquired print logs, a number of prints within a particular period for each of the plurality of label data stored in the label database; and
in response to receiving a suggestion request from the second information processing apparatus, suggesting label data having a high print frequency based on the counted number of prints for each of the plurality of label data.

14. A label data sharing system comprising a first information processing apparatus, a second information processing apparatus, and a server, the first information processing apparatus and the second information processing apparatus being connectable to the server via a network,
the server being configured to access a label database, the label database being configured to store a plurality of label data and label IDs identifying respective ones of the plurality of label data,
the first information processing apparatus being configured to perform:
specifying one of the plurality of label data stored in the label database and downloading, from the server, specified label data and a label ID identifying the specified label data; and
in a case where the first information processing apparatus causes a label printer to perform printing based on the label data received from the server, outputting a print log to the server, the print log including time information and the label ID identifying the printed label data;
the server being configured to perform:
counting, based on the print log, a number of prints within a particular period for each of the plurality of label data stored in the label database; and
in response to receiving a suggestion request from the second information processing apparatus, suggesting label data having a high print frequency based on the counted number of prints for each of the plurality of label data.
